(19) United States
(12) Patent Application Publication
(10) Pub. No.: US 2008/0134828 A1
(43) Pub. Date: Jun. 12, 2008

(54) APPARATUS FOR AUTOMATICALLY CONTROLLING TENSION OF PARKING BRAKE CABLE

(75) Inventors: Hee-gon Lee, Gyeongsan (KR); In-tae Hwang, Gyeongsan (KR)

Correspondence Address: EDWARDS ANGELL PALMER & DODGE LLP, P.O. BOX 55874, BOSTON, MA, 02205, US

(73) Assignee: SL CORPORATION, Daegu (KR)

(21) Appl. No.: 11/946,890

(22) Filed: Nov. 29, 2007

(30) Foreign Application Priority Data
Dec. 6, 2006 (KR) 10-2006-0123142

(51) Int. Cl. F16C 1/12

(52) U.S. Cl. 74/501.6

(57) ABSTRACT

An apparatus for automatically controlling the tension of a cable of a parking brake is provided. The apparatus includes a housing that is moved upon the manipulation of the manipulation lever and includes a first inclined surface that is formed on an inner surface of a first end of the housing; a rod that passes through the housing and includes teeth that are formed on a portion of the rod in the housing; a first elastic member that is disposed on one side of the housing and is penetrated by the rod; a rod holder that is connected to the rod and supports the first elastic member; a second elastic member that is disposed in the housing and is penetrated by the rod; a tension control module which is disposed in the housing, is penetrated by the rod, is connected to the second elastic member so as to be able to move along the rod due to an elastic force of the second elastic member, and includes teeth and a plurality of second inclined surfaces that define an outer circumferential surface of one end of the tension control module and that correspond to the first inclined surface, wherein, if the first inclined surface contacts the second inclined surfaces, the tension control module is moved toward the rod so that the teeth of the tension control module can engage with the teeth of the rod; a cable stopper that is penetrated by the rod and is inserted into the housing so as to be able to move along the rod; and a stopper that is fixed to an exterior of the housing and prevents movement of the cable stopper.

### CROSS REFERENCE TO RELATED APPLICATION

This application claims priority from Korean Patent Application No. 10-2006-0123142 filed on Dec. 6, 2006 in the Korean Intellectual Property Office, the disclosure of which is incorporated herein by reference in its entirety.

### BACKGROUND OF THE INVENTION

1. Field of the Invention

The present invention relates to an apparatus for automatically controlling the tension of a parking brake cable, and, more particularly, to an apparatus for automatically controlling the tension of a cable of a parking brake in which an appropriate tension can be maintained by appropriately straining a cable of a parking brake using the elastic force of a spring when the cable is stretched.

2. Description of the Related Art

In general, parking brake apparatuses for vehicles apply a parking brake to rear wheels of a vehicle in order to maintain a parked state of the vehicle. Parking brake apparatuses include a parking brake drum, a parking brake shoe, and a spring and apply a parking brake to rear wheels by using friction that results from the firm attachment of the parking brake shoe to the parking brake drum.

A parking brake may be applied by straining a cable using a manipulation lever which is provided near a driver's seat and can be rotated. The cable is connected to a left parking brake cable and a right parking brake cable. When the manipulation lever is pulled, the left and right parking brake cables are both strained, thereby applying the parking brake. When the manipulation lever is released, the left and right parking brake cables are both loosened, thereby releasing the parking brake.

Therefore, in order to smoothly transmit the force to manipulate a manipulation lever to left and right parking brake cables, the tension of a cable must be uniformly maintained. However, a cable may be stretched after extended use or due to an impact such as vibration or physical shock, a high temperature, or deteriorated durability, thereby making it difficult to uniformly maintain the tension of the cable.

In short, when a cable of a parking brake apparatus is stretched too much, it is difficult to properly operate the parking brake apparatus simply using a manipulation lever.

### SUMMARY OF THE INVENTION

The present invention maintains an appropriate tension by appropriately straining a cable of a parking brake using the elastic force of a spring when the cable is stretched.

However, the objectives of the present invention are not restricted to the ones set forth herein. The above and other objectives of the present invention will become apparent to one of daily skill in the art to which the present invention pertains by referencing the detailed description of the present invention given below.

According to an aspect of the present invention, there is provided an apparatus for automatically controlling the tension of a cable which transmits a force of a manipulation lever to a parking brake, the apparatus including a housing which is moved upon the manipulation of the manipulation lever and includes a first inclined surface that is formed on an inner surface of a first end of the housing; a rod which passes through the housing and includes teeth that are formed on a portion of the rod in the housing; a first elastic member which is disposed on one side of the housing and is penetrated by the rod; a rod holder which is connected to the rod and supports the first elastic member; a second elastic member which is disposed in the housing and is penetrated by the rod; a tension control module which is disposed in the housing, is penetrated by the rod, is connected to the second elastic member so as to be able to move along the rod due to an elastic force of the second elastic member, and includes teeth and a plurality of second inclined surfaces that define an outer circumferential surface of one end of the tension control module and that correspond to the first inclined surface, wherein, if the first inclined surface contacts the second inclined surfaces, the tension control module is moved toward the rod so that the teeth of the tension control module can engage with the teeth of the rod; a cable stopper which is penetrated by the rod and is inserted into the housing so as to be able to move along the rod; and a stopper which is fixed to an exterior of the housing and prevents movement of the cable stopper.

### BRIEF DESCRIPTION OF THE DRAWINGS

The above and other features and advantages of the present invention will become apparent by describing in detail preferred embodiments thereof with reference to the attached drawings in which:

FIG. 1 illustrates an exploded perspective view of a parking brake apparatus according to an embodiment of the present invention;

FIG. 2 illustrates a perspective view of the parking brake apparatus illustrated in FIG. 1;

FIG. 3 illustrates an exploded view of the parking brake apparatus illustrated in FIG. 1;

FIG. 4 illustrates an apparatus for automatically controlling the tension of a cable of a parking brake according to an embodiment of the present invention;

FIG. 5 illustrates a cross-sectional view of the apparatus illustrated in FIG. 4;

FIG. 6 illustrates a cross-sectional view of the apparatus illustrated in FIG. 4 when a parking brake is applied;

FIG. 7 illustrates the engagement of teeth of a segment unit with teeth of a rod; and

FIG. 8 illustrates a cross-sectional view of the apparatus illustrated in FIG. 4 when a parking brake is released.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and repeated descriptions have been omitted.

A parking brake apparatus according to an embodiment of the present invention will hereinafter be described in detail.

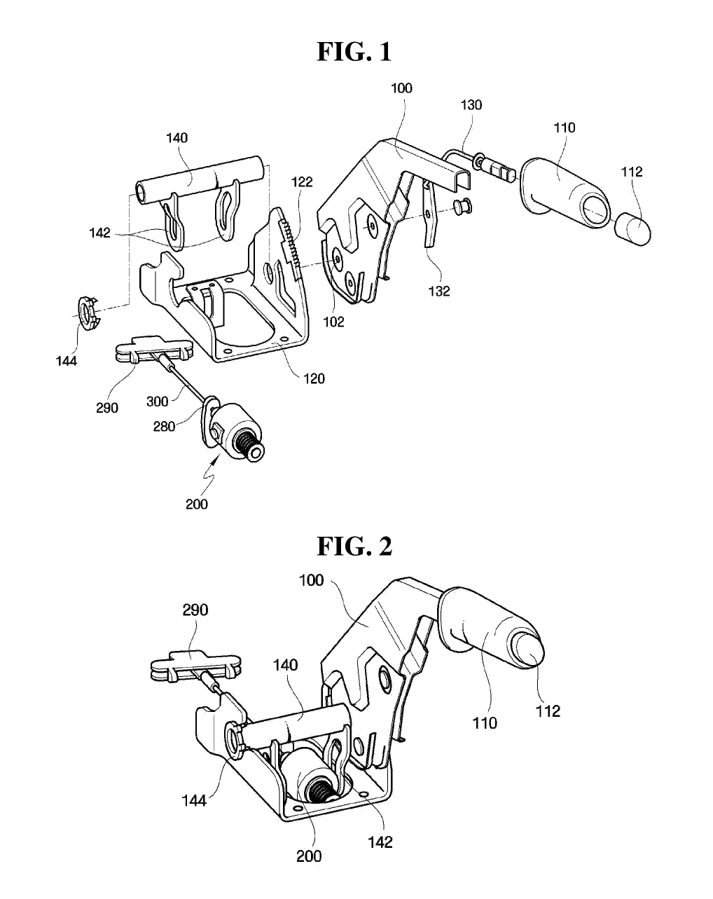

FIG. 1 illustrates an exploded perspective view of a parking brake apparatus according to an embodiment of the present invention, and FIG. 2 illustrates a perspective view of the parking brake apparatus.

Referring to FIGS. 1 and 2, a manipulation lever 100 is coupled to a bracket 120 so as to be rotatable. Specifically, the manipulation lever 100 may be rotated by grabbing a grip 110, and then pulling or releasing the grip 110. An operating rod 130 is disposed in the manipulation lever 100. A pole 132, which is connected to one end of the operating rod 130, may engage with a stopper 122, which is formed at the bracket 120, and may thus fix the manipulation lever 100. A button 112, which is formed at one end of the grip 110, is connected to the other end of the pole 130. When a driver presses the button 112, the pole 130 is rotated so that the pole 130 can escape the stopper 122, and can thus freely move the manipulation lever 100.

A shaft 140 is coupled to a bush 144 by penetrating both sides of the bracket 120 along the direction of a rotation axis 102. A pair of coupling arms 142 are attached to the shaft 140. The coupling arms 142 are connected to an apparatus 200 for automatically controlling the tension of a cable of a parking brake according to an embodiment of the present invention, and, more particularly, to a housing 210 of the apparatus 200. Therefore, as the manipulation lever 100 is moved, the shaft 140 is rotated in accordance with the movement of the manipulation lever 100, and the housing 210 to which the coupling arms 142 are connected is moved in accordance with the rotation of the shaft 140.

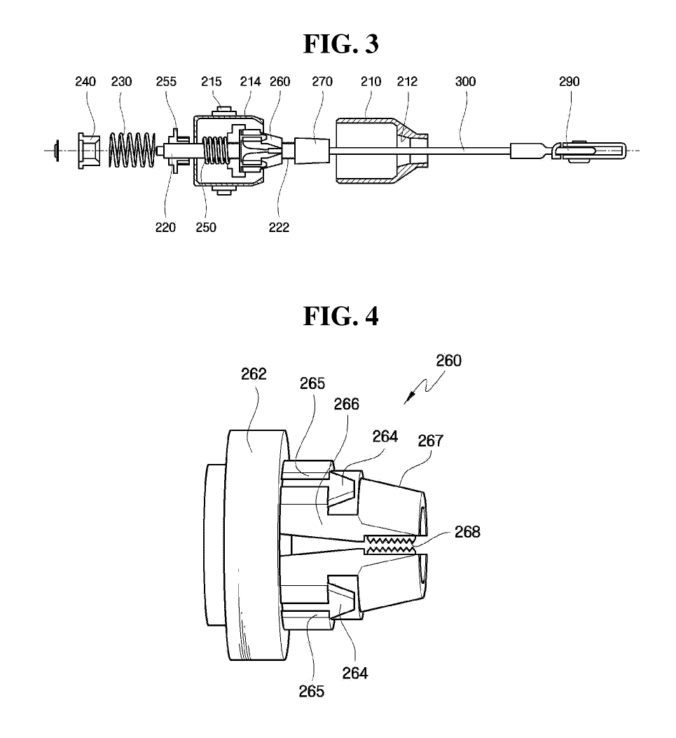

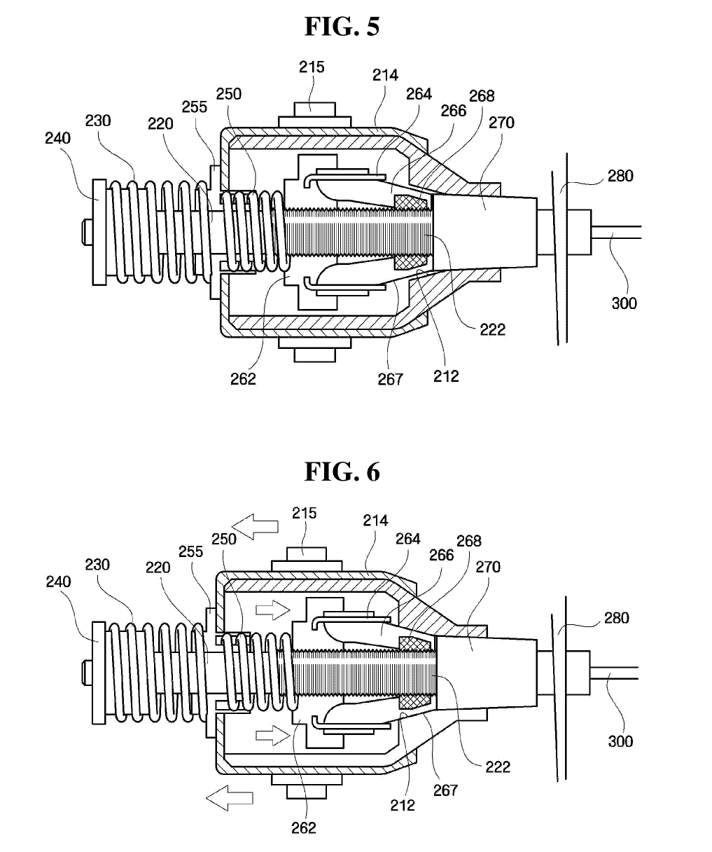

FIG. 3 illustrates an exploded view of the apparatus 200, FIG. 4 illustrates a tension control module 260 of the apparatus 200, and FIG. 5 illustrates a cross-sectional view of the apparatus 200.

Referring to FIG. 3, the apparatus 200 includes the housing 210, a rod 220, a first elastic member 230, a rod holder 240, a second elastic member 250, the tension control module 260, a cable stopper 270, and a stopper 280. The apparatus 200 may also include an equalizer 290.

The housing 210 is penetrated by the rod 220 which is connected to the cable 300. The second elastic member 250, the tension control module 260, and the cable stopper 270 are disposed in the housing 210. The housing 210 has a first inclined surface 212 so that the inner diameter of the housing 210 becomes narrower toward the cable 300. The first inclined surface 212 may come in contact with a plurality of second inclined surfaces 267 of the tension control module 260 according to the lateral movement of the housing 210 along the rod 220.

The apparatus 200 may also include a housing cover 214. The housing 210 is inserted into the housing cover 214, and is thus fixed by the housing cover 214. The housing 210 or the housing cover 214 is coupled to the coupling arms 142 of FIG. 1, and may thus be rotated by the rod 220 in accordance with the rotation of the shaft 140. A pair of protrusions 215 are formed on an external sidewall of the housing cover 214. The protrusions 215 may be respectively inserted into and thus coupled to the grooves of the coupling arms 142.

The cable 300 is connected to the rod 220. The rod 220 passes through the housing 210. The rod 220 is inserted into the first elastic member 230. Due to the rod holder 240, the first elastic member 230 can be prevented from deviating from the rod 220. Teeth 222 such as screw threads are formed on a predetermined portion of the rod 220 in the housing 210. The teeth 222 of the rod 220 may engage with teeth 268 of the tension control module 260.

The first elastic member 230 is penetrated by the rod 220. The rod 220 is inserted into the first elastic member 230. The first elastic member 230 is supported by the rod holder 240, which is formed at one end of the rod 220, and is disposed between the rod holder 240 and the housing 210. Specifically, the first elastic member 230 may be a compression coil spring. The first elastic member 230 is compressed initially. When the cable 300 is stretched too much after extended use or due to an impact, high temperature, or deteriorated durability, the cable 300 may be strained by extending the first elastic member 230 by the amount by which the cable 300 is stretched using an elastic force of the first elastic member 230. A spring holder 255 may be formed between the first elastic member 230 and the housing 210, as illustrated in FIG. 3. Referring to FIG. 3, the spring holder 255 is inserted into and thus fixed to a hole which is formed at the bottom of the housing 210. The spring holder 255 supports the first elastic member 230, which is disposed outside the housing 210, and fixes the second elastic member 250, which is disposed inside the housing 210.

The rod holder 240 is coupled to the rod 220 and supports the first elastic member 230.

The rod 220 passes through the second elastic member 250 and is inserted into the second elastic member 250. The second elastic member 250 is disposed between the bottom of the housing 210 and the tension control module 260. As described above, when the spring holder 255 is inserted into the housing 210, the second elastic member 250 can be inserted into and thus fixed to the spring holder 255. The second elastic member 250, like the first elastic member 230, may be a compression coil spring. The second elastic member 230 moves the tension control module 260 along the rod 220 using its elastic force.

The tension control module 260 is disposed between the second elastic member 250 and the cable stopper 270. The tension control module 260 is penetrated by the rod 220. The tension control module 260 has the second inclined surfaces 267 which define an outer circumferential surface of a first end portion of the tension control module 260. The first end portion of the tension control module 260 is on the opposite side of a second end portion of the tension control module 260 which is coupled to the second elastic member 250. The second inclined surfaces 267 correspond to the first inclined surface 212 of the housing 210. As the tension control module 260 is moved laterally along the rod 220 by the elastic force of the second elastic member 250, the first inclined surface 212 may come in contact with the second inclined surfaces 256. The teeth 268 may be formed on an inner surface of the end portion of the tension control module 260 with the second inclined surfaces 267. The teeth 268 may engage with or disengage from the teeth 222 of the rod 222. That is, as the tension control module 260 is moved along the rod 220 upon the extension of the second elastic member 250, the first inclined surface 212 may come in contact with the second inclined surfaces 267. When the first inclined surface 212 is placed in contact with the second inclined surface 267, the first inclined surface 212 presses the second inclined surfaces 267 so that the teeth 268 can be moved toward the rod 220. Therefore, the tension control module 260 and the rod 220 may be coupled by engaging the teeth 268 of the tension control module 260 with the teeth 222 of the rod 220.

FIG. 4 illustrates the tension control module 260. Referring to FIG. 4, the tension control module 260 includes a base unit 262, a plurality of plate springs 264, a plurality of segment units 266, and teeth 268.

The base unit 262 is connected to the second elastic member 250 and can thus be influenced by the elastic force of the second elastic member 250. A predetermined number of plate springs 264, for example, four plate springs 264, may be disposed on an outer circumferential surface of the base unit 262. The plate springs 264 may be formed through insert molding so that the plate springs 264 can be fixed to the base unit 262.

The plate springs 264 are fixed to the base unit 262, and extend in the longitudinal direction of the rod 220.

The second inclined surfaces 267 are respectively formed on the segment units 266. The segment units 266 are respectively coupled to the plate springs 264. Specifically, the plate springs 264 may be respectively inserted into guide grooves 265 of the segment units 266, and may thus be coupled to the segment units 266 using a snap-fit method.

The teeth 268 are fixed onto the inner circumferential surfaces of the segment units 266. The teeth 268 may be formed through insert molding so that the teeth 268 can be fixed to the segment units 266. The teeth 268 may be formed in one body with the segment units 266.

As the tension control module 260 is moved along the rod 220 upon the extension of the second elastic member 250, the first inclined surface 212 of the housing 210 may come in contact with the second inclined surfaces 267 of the segment units 266. When the first inclined surface 212 contacts the second inclined surfaces 267, the first inclined surface 212 presses the second inclined surfaces 267, and the segments 266 are moved toward the rod 220 due to the elasticity of the plate springs 264. As the segments 266 are moved toward the rod 220, the teeth 268 may become engaged with the teeth 222 of the rod 220, thereby coupling the tension control module 260 and the rod 220. When the manipulation lever 100 is released, the tension control module 260 is moved along the rod 220 upon the compression of the second elastic member 250 in the opposite direction to that in which the tension control module 260 is moved upon the extension of the second elastic member 250. Therefore, the second inclined surfaces 267 may become detached from the first inclined surface 212. As a result, the force with which the first inclined surface 212 presses the second inclined surfaces 267 may gradually decrease, and the segments 266 may be moved so as to gradually become distant from the rod 220 due to the elasticity of the plate springs 264. Thus, the teeth 268 of the tension control module 260 may become disengaged from the teeth 222 of the rod 220, thereby separating the tension control module 260 from the rod 220.

The cable stopper 270 is disposed between the tension control module 260 and the stopper 280, and is penetrated by the rod 220. One end of the cable stopper 270 is inserted into a hole of the housing 210, and the other end of the cable stopper 270 is disposed between the tension control module 260 and the stopper 280 outside the housing 210. As the housing 210 is moved, the cable stopper 270 may become placed in contact with the stopper 280. The movement of the tension control module 260 according to whether the cable stopper 270 contacts the stopper 280 will be described later in detail with reference to FIGS. 6 through 8.

The stopper 280 is disposed on one side of the cable stopper 270 outside the housing 210. The stopper 280 is fixed to a predetermined location and can thus prevent the movement of the cable stopper 270.

The equalizer 290 is disposed at one end of the cable 300, collects left and right brake cables (not shown), and applies the same force to the left and right brake cables. The shape and operation of the equalizer 290 are well known to one of ordinary skill in the art to which the present invention pertains, and, thus, detailed descriptions of the shape and operation of the equalizer 290 have been skipped.

An operation of the apparatus 200 will hereinafter be described in detail with reference to FIGS. 6 through 8.

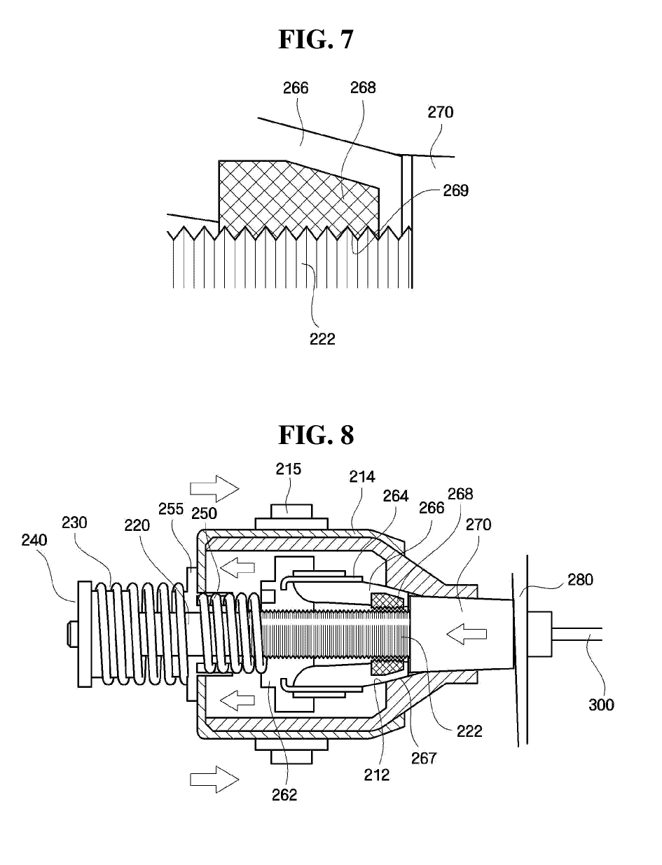

Specifically, an operation of the apparatus 200 when a parking brake is applied will hereinafter be described in detail with reference to FIGS. 6 and 7, and an operation of the apparatus 200 when the parking brake is released will hereinafter be described in detail with reference to FIG. 8.

FIG. 6 illustrates the apparatus 200 when a parking brake is applied, and FIG. 7 illustrates the engagement of the teeth 268 with the teeth 222.

Referring to FIGS. 6 and 7, when a driver pulls the manipulation lever 100, the shaft 140 is rotated. As a result, the housing 210, which is connected to the coupling arms 142 of the shaft 140, is moved so as to gradually become distant from the stopper 280.

Initially, the cable stopper 270 is placed in contact with the stopper 280, and is thus prevented from moving along the rod 220. As the housing 210 is moved, the cable stopper 270 becomes detached from the stopper 280. As a result, the force with which the stopper 280 pushes the cable stopper 270 disappears, and thus, the second elastic member 250 is extended. Therefore, the tension control module 260 is moved along the rod 220 upon the extension of the second elastic member 250, and the second inclined surfaces 267 of the segment units 266 become placed in contact with the first inclined surface 212 of the housing 210. Then, the first inclined surface 212 presses the second inclined surfaces 267 so that the segment units 266 can inwardly bend closer to the rod 220 due to the elasticity of the plate springs 264. As a result, the teeth 268 of the segment units 266 engage with the teeth 222 of the rod 220, thereby coupling the tension control module 260 and the rod 220. The engagement of the teeth 268 with the teeth 222 is illustrated in FIG. 7.

Thereafter, if the housing 210 is moved further by the manipulation lever 100 when the tension control module 260 and the rod 220 are coupled, the cable 300 may be strained, thereby extending the first elastic member 230. The length by which the cable 300 is strained is compensated for by the amount by which the first elastic member 230 is extended. As the housing 210 is moved by a predetermined distance, the tension control module 260 and the rod 220 are coupled. Thereafter, if the housing 210 is moved further, the cable 330, which is connected to the rod 220, may be strained. In this manner, it is possible to uniformly maintain the tension of the cable 300.

FIG. 8 illustrates a cross-sectional view of the apparatus 200 when a parking brake is released. Referring to FIG. 8, if the manipulation lever 100 is released when the housing 210 is moved away from the stopper 280 by pulling the manipulation lever 100, the housing 210 may be moved back toward the stopper 280.

As the housing 210 is moved toward the stopper 280, the cable stopper 270 becomes placed in contact with stopper 280. The stopper 280 is fixed. Thus, as the housing 210 is moved toward the stopper 280, the cable stopper 270 gradually pushes the tension control module 260 into the housing 210, and the second elastic member 250 is compressed. As a result, the tension control module 260 may be moved inside the housing 210, as illustrated in FIG. 8, and thus, the first inclined surface 212 of the housing 210 may no longer be in contact with the second inclined surfaces 267. Therefore, the force with which the first inclined surface 212 presses the second inclined surfaces 267 disappears, and, thus, the segment units 266 of the tension control module 260 are drawn away from the rod 220. Accordingly, the teeth 222 of the rod 220 no longer engage with the teeth 268 of the segment units 266, and the tension control module 260 and the rod 220 are separated so that the tension generated by coupling the tension control module 260 and the rod 220 disappears.

As described above, according to the present invention, it is possible to enhance the operating reliability of a parking brake by uniformly maintaining the tension of a cable even when the cable is stretched.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for automatically controlling the tension of a cable that transmits a force of a manipulation lever to a parking brake, the apparatus comprising:
a housing which is moved upon manipulation of the manipulation lever and comprises a first inclined surface that is formed on an inner surface of a first end of the housing;
a rod that passes through the housing and comprises teeth that are formed on a portion of the rod in the housing;
a first elastic member that is disposed on one side of the housing and is penetrated by the rod;
a second elastic member that is disposed in the housing and is penetrated by the rod;
a tension control module that is disposed in the housing, is penetrated by the rod, is connected to the second elastic member so as to be able to move along the rod due to an elastic force of the second elastic member, and comprises teeth and a plurality of second inclined surfaces that define an outer circumferential surface of one end of the tension control module and that correspond to the first inclined surface, wherein, if the first inclined surface contacts the second inclined surfaces, the tension control module is moved toward the rod so that the teeth of the tension control module can engage with the teeth of the rod;
a cable stopper that is penetrated by the rod and is inserted into the housing so as to be able to move along the rod; and
a stopper that is fixed to an exterior of the housing and prevents movement of the cable stopper.

2. The apparatus of claim 1, wherein the first elastic member and the second elastic member are compression coil springs.

3. The apparatus of claim 1, wherein the tension control module further comprises:
a base unit that is connected to the second elastic member, and is influenced by the elastic force of the second elastic member;
a plurality of plate springs that are disposed on an outer circumferential surface of the base unit, extend in a longitudinal direction of the rod, and are fixed to the base unit;
a plurality of segment units that are respectively coupled to the plate springs and comprise the second inclined surfaces; and
teeth that are fixed to inner circumferential surfaces of the segment units.

4. The apparatus of claim 3, wherein the segment units are respectively coupled to the plate springs using a snap-fit method by inserting the plate springs into respective corresponding guide grooves that are disposed on the segment units.

5. The apparatus of claim 1, further comprising:
a rod holder that is connected to the rod and supports the first elastic member.
